(19) United States
(12) Patent Application Publication
(10) Pub. No.: US 2009/0297135 A1
(43) Pub. Date: Dec. 3, 2009

(54) SYSTEM AND METHOD FOR MOTION DETECTION ASSISTED PHOTOGRAPHY

(76) Inventors: BARRY E. WILLNER, Briarcliff Manor, NY (US); Innes Challoner Read, Winchester (GB); Robert Cameron Weir, Westford, MA (US); Patrick Joseph O'Sullivan, Ballsbridge (IE); Edith Helen Stern, Yorktown Heights, NY (US)

Correspondence Address: HOLLAND & KNIGHT, 10 ST. JAMES AVENUE, BOSTON, MA, 02116-3889, US

(21) Appl. No.: 12/131,436

(22) Filed: Jun. 2, 2008

(51) Int. Cl. G03B 17/00

(52) U.S. Cl. 396/153

(57) ABSTRACT

A method, computer program product, and camera system detect a change in motion of at least a portion of an object framed in a viewing field of a camera. At least one picture of the object is taken based upon, at least in part, the change in motion of at least a portion of the object if a level of light is at least a predefined threshold level of light.

### TECHNICAL FIELD

This disclosure relates to photography, and more particularly to a system and method for motion detection assisted photography.

### BACKGROUND

Photography and camera technology has advanced greatly since the days of the daguerreotype. Autofocus, image stabilization technology and the ability to control depth of focus and shutter speed enable taking better pictures than was previously possible. However, the shutter of a camera is still typically triggered manually or by a timer mechanism. Human reflexes are often not fast enough to catch an object initiating or stopping motion and it is often more difficult to use a timer mechanism to catch such things. Therefore, there exists a need for camera technology that triggers the shutter based upon a detection of a change in motion.

### SUMMARY OF THE DISCLOSURE

In a first implementation, a method includes detecting a change in motion of at least a portion of an object framed in a viewing field of a camera. At least one picture of the object may be taken upon the detection of the change in motion of the at least a portion of the object if a level of light is at least a predefined threshold level of light,.

One or more of the following features may be included. The camera may include one of a chemical film based camera, a digital camera, a video camera, a web camera and a camera phone. The change in motion of at least a portion of the object may include one or more of a start of motion of at least a portion of the object and a stop of motion of at least a portion of the object.

At least a second picture may be taken after a predefined interval of time. Taking at least a second picture after a predefined interval of time may include taking a plurality of pictures at predefined time intervals. A predetermined number of pictures may be taken over a predefined period of time.

The level of light may be detected.

According to another implementation, a computer program product may reside on a computer readable medium having a plurality of instructions stored on it. When executed by a processor, the instructions cause the processor to perform operations including detecting a change in motion of at least a portion of the object framed in a viewing field of a camera. The instructions further cause the processor to take at least one picture of the object upon the detection of the change in motion of at least a portion of the object if a level of light is at least a predefined threshold level of light,.

One or more of the following features may be included. The camera may include one of a chemical film based camera, a digital camera, a video camera, a web camera and a camera phone. The change in motion of at least a portion of the object may include one or more of a start of motion of at least a portion of the object and a stop of motion of at least a portion of the object.

The instructions may further cause the processor to take at least a second picture after a predefined interval of time. The instructions may further cause the processor to take a plurality of pictures at predefined time intervals. The instructions may further cause the processor to take a predetermined number of pictures over a predefined period of time.

The instructions may further cause the processor to detect the level of light.

According to another implementation, a camera system includes an imaging device configured to take one or more pictures of one or more objects within a viewing field. A motion detection device configured to detect a change in motion of at least a portion of the one or more objects within the viewing field, and to provide a motion detection signal based upon, at least in part, the detected change in motion. The camera system also includes a processor configured to receive the motion detection signal from the motion detection device and to trigger the imaging device to take the one or more pictures based upon, at least in part, the motion detection signal if a level of light is at least a predefined threshold level of light.

One or more of the following features may be included. A light meter may be configured to measure a light level available to the imaging device, and to provide a light level signal, based upon, at least in part, the measured light level, to the processing logic. The processing logic may be configured to trigger the imaging device to take one or more pictures if the light level signal indicates a measured light level greater than a predefined threshold light level. A flash device may be configured to achieve the at least a predefined threshold level of light available to the imaging device.

The change in motion of the at least a portion of the object may include one or more of a start of motion of at least a portion of the object and a stop of motion of at least a portion of the object. The imaging device may include one of a chemical film based imaging device, a digital imaging device, and a video imaging device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a motion triggering process coupled to an image capturing device.

FIG. 2 is a flowchart of a process executed by the motion triggering process of FIG. 1.

FIG. 3 diagrammatically depicts a viewing field of the image capturing device of FIG. 1 having an object framed therein.

FIG. 4 diagrammatically depicts a viewing field of the image capturing device of FIG. 1 having an object framed therein.

FIG. 5 diagrammatically depicts a viewing field of the image capturing device of FIG. 1 having an object framed therein.

### DETAILED DESCRIPTION

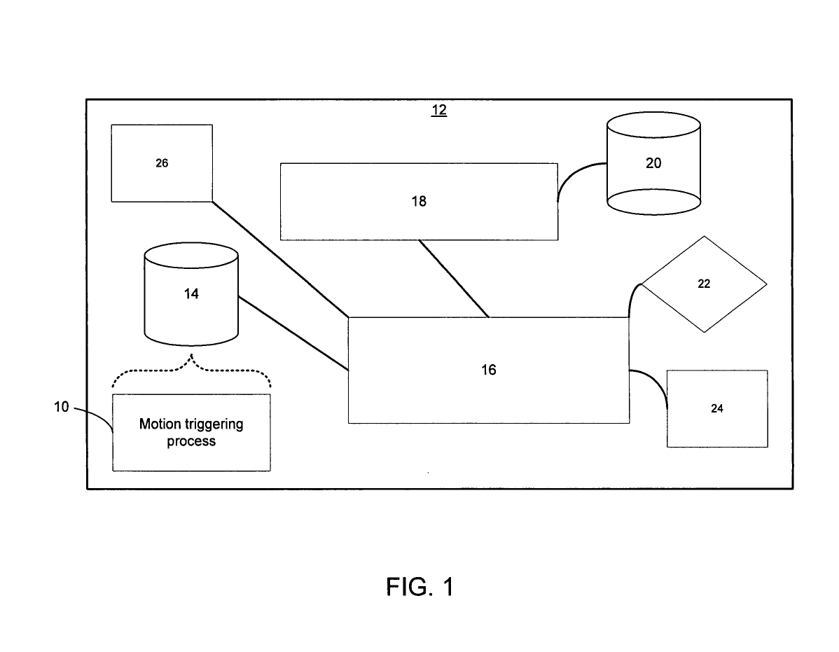

Referring to FIG. 1, there is shown a motion triggering process 10 that may reside on and may be executed by an image capturing device (e.g., camera system 12). Camera system 12 may include, for example, a chemical film based camera, a digital camera, a video camera, a web camera, and a camera phone. The instruction sets and subroutines of motion triggering process 10, which may be stored on storage device 14 coupled to camera system 12, may be executed by one or more processors, (e.g., processor 16) and one or more memory architectures (not shown) incorporated into camera system 12. Storage device 14 may include but is not limited to: a hard disk drive; a tape drive; an optical drive; a RAID array; a random access memory (RAM); a read-only memory (ROM); compact flash (CF) storage devices; secure digital (SD) storage devices; and memory stick storage devices.

Camera system 12 may include imaging device 18 configured to take one or more pictures of one or more objects within a viewing field of imaging device 18. As mentioned above, camera system 12 may include, for example, a chemical film based camera, a digital camera, a video camera, a web camera and a camera phone. As such, imaging device 18 may include, but is not limited to, a chemical film based imaging device (e.g., which may be capable of capturing an image on one or more frames of chemical based photographic film, or a photographic plate), and a digital imaging device, such, but not limited to, a charge coupled device (CCD) or a complementary metal-oxide-semiconductor (CMOS) sensor capable of image capture. Imaging device 18, which may include a chemical film based imaging device and/or a digital imaging device may be configured as a video imaging device, e.g., which may be capable of capturing a sequence of still images that may be capable or representing scenes in motion.

Imaging device 18 may include a shutter mechanism (not shown) and may be coupled to one or more of storage devices 14, 20 configured to store pictures taken by camera system 12. Storage device 20 may include, but is not limited to, a chemical film based storage device (e.g., including one or more frames of chemical based photographic film and/or a photographic plate), and an electronic storage device (e.g., a hard disk drive, a tape drive, an optical drive, a RAID array, a random access memory, a read only memory, compact flash (CF) storage devices, secure digital (SD) storage devices, and memory stick storage devices). Camera system 12 may include one or more lenses (not shown), an auto-focusing mechanism (not shown), and a range-finding mechanism (not shown), which may be coupled to imaging device 18. Imaging device 18 may be coupled to processor 16, and may be configured to send one or more signals to imaging device 18 for triggering imaging device 18 to take one or more pictures.

Motion detection device 22 may be configured to detect a change in motion of at least a portion of the one or more objects within the viewing field. Motion detection device 22 may include a motion sensor that transforms the detection of motion into an electric signal, for example, by measuring optical or acoustical changes in the viewing field. The motion sensor may be a passive infrared sensor (PIR), an ultrasonic sensor, or a microwave sensor. Motion detection device 22 may be configured to detect such changes in motion such as the object opening its eyes and/or having its eyes open or the object smiling. Similarly, motion detection device 22 may be configured to detect a change in motion of the object indicating that the object is facing and/or looking at camera system 12.

According to a further example, rather than including a discrete motion detection device (e.g., motion detection device 22) motion triggering process 10 may receive an indication of motion, e.g., based upon, at least in part, a change in an auto-focus setting and/or an input from the auto-focusing mechanism. Such a change in the auto-focus setting and/or input from the auto-focusing mechanism may be indicative of a change in motion, e.g., which may necessitate the change in auto-focus setting and/or may result in the auto-focusing mechanism providing the input to motion triggering process 10.

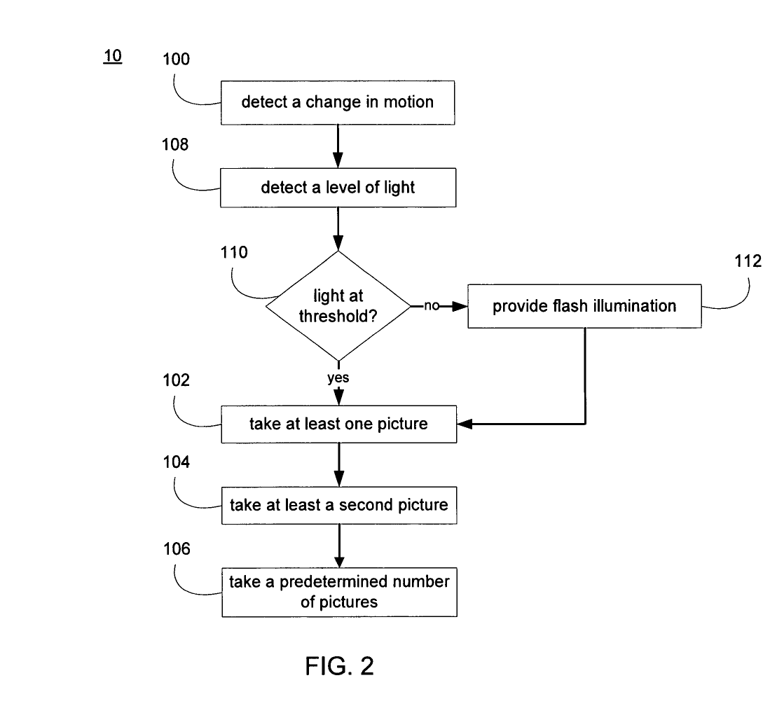

Referring also to FIG. 2, motion triggering process 10 may detect 100 a change in motion of at least a portion of an object framed in a viewing field of camera system 12 (e.g., framed within a viewing field of imaging device 18). Triggering process 10 may further take 102 at least one picture of the object framed within the viewing field of camera system 12 upon detecting the change in motion of at least a portion of the object framed within the viewing field of camera system 12. Taking 102 at least one picture of the object framed within the viewing field of camera system 12 may include taking the at least one picture after a predetermined time interval after detecting 100 the change in motion of at least a portion of the object.

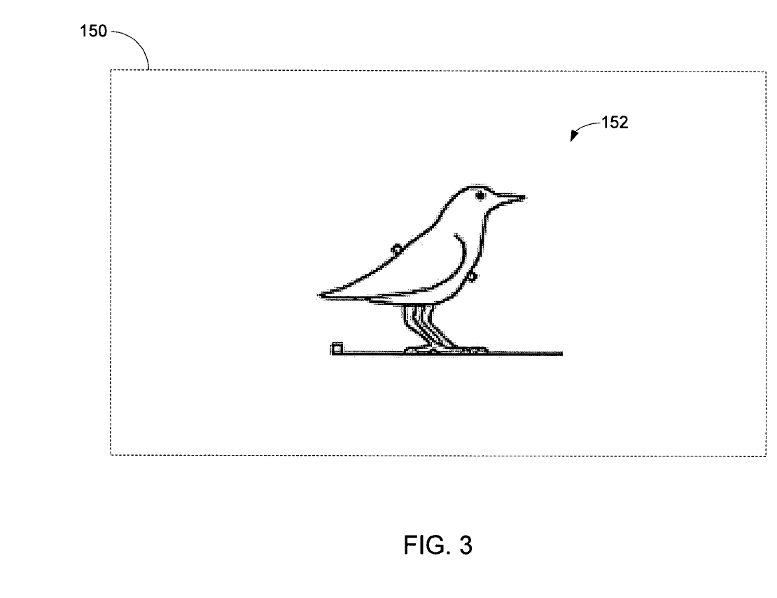

For example, and referring also to FIG. 3, viewing field 150 of imaging device 18 may represent the field of an image that may be captured by imaging device 18. An object (e.g., bird 152) may be framed within viewing field 150 such that imaging device 18 may capture an image of bird 152. It may be desirable to take a picture of bird 152 as it lands or takes off. However, timing the taking of the picture to capture the change in motion of bird 152 may be difficult to achieve manually.

Bird 152 may be framed in viewing field 150, e.g., by a user (not shown) looking through a view finder or a at screen on the camera and adjusting (e.g., including focusing, zooming in/out, etc.) viewing field 150 to capture bird 152. If the camera is remotely controlled, e.g., a web camera, framing bird 152 in viewing field 150 may be accomplished remotely, for example, by using a feedback image provided from imaging device 18 of a web camera over a network, e.g., the Internet, to a computing device.

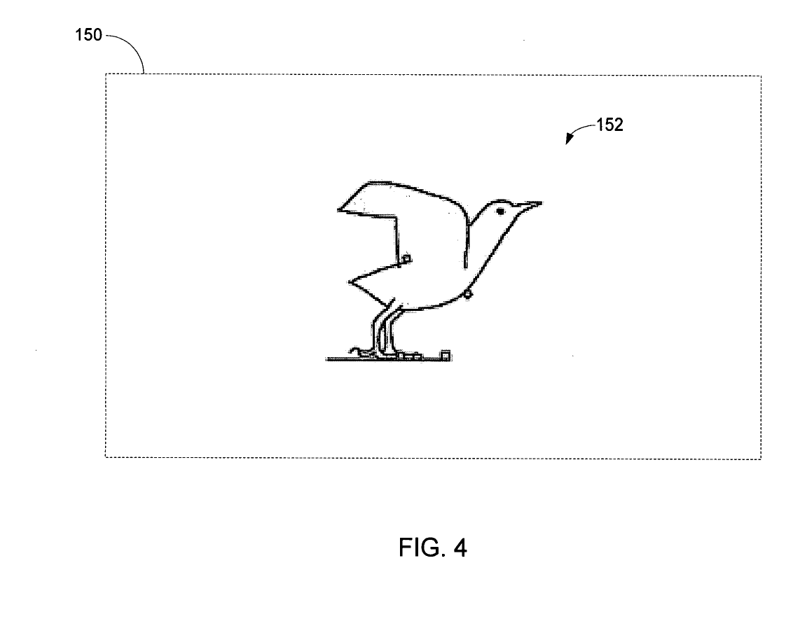

Continuing with the above-stated example, and referring also to FIG. 4, bird 152 framed within viewing field 150 may move, e.g., may begin to take flight. When bird 152 begins to take flight, motion triggering process 10 may detect 100 a change in motion of at least a portion of bird 152 framed in viewing field 150. For example, camera system 12 may further include a motion detection device 22, e.g., which may monitor the motion of at least a portion of bird 152. Motion detection device 22 may provide a motion detection signal based upon, at least in part, a detected change in motion of bird 152. For example, motion detection device 22 may include, but is not limited to, an optical motion detection device, an ultrasonic motion detection device, a microwave motion detection device, or the like. Further, and as discussed above, motion triggering process 10 may detect 100 a change in motion of at least a portion of bird 152 based upon, at least in part, a change in an auto-focus setting and/or an input provided by an auto-focusing mechanism. For example, the change in motion of bird 152 may necessitate a change in the auto-focus setting, e.g., as a point of focus of at least a portion of bird 152 changes. The change in the point of focus of at least a portion of bird 152 may result in a change in the auto-focus setting, e.g., as the auto-focusing mechanism adjusts the focus of camera system 12 (e.g., the focus of one or more lenses) in an attempt to maintain an appropriate focus on bird 152.

Motion triggering process 10 may detect 100 a change in motion of bird 152 via motion detection device 22 and/or a change in auto-focus setting or input from auto-focusing mechanism. The change in motion of at least a portion of bird 152 may include, for example, one or more of a start of motion of at least a portion of bird 152 (e.g., as bird 152 begins to take flight). Similarly, the change in motion detected 100 by motion triggering process 10 may include a stop of motion of at least a portion of the object framed in the viewing field. As shown, e.g., in FIG. 3, bird 152 may be stationary when initially framed in viewing field 150. When bird 152 begins to take flight, e.g., as shown in FIG. 4, motion detection device 22 may provide a motion detection signal (e.g., which may be received by motion triggering process 10) based upon, at least in part, the detected change in motion. Upon detecting 100 the change in motion (e.g., via motion detection signal from motion detection device 22) of bird 152, motion triggering process 10 (e.g., executed, at least in part by processor 16) may cause imaging device 18 to take 102 at least a first picture of bird 152 as bird 152 takes flight. Further, taking 102 the at least a first picture of bird 152 upon detecting 100 a change in motion of bird 152 may include taking 102 the at least a first picture of bird 152 at a predetermined time interval (e.g., 0.5 second, 1.0 second, etc.) after detecting 100 the change in motion of bird 152.

While the preceding description has discussed a change in motion including a start of motion, as mentioned above, the change in motion detected 100 by motion triggering process 10 (e.g., via motion detection device 22) may include a stop or decrease in motion. For example, if the object is in motion when initially framed in viewing field 150, motion triggering process (e.g., via motion detection device 22) may detect 100 a change in motion when the object ceases to move.

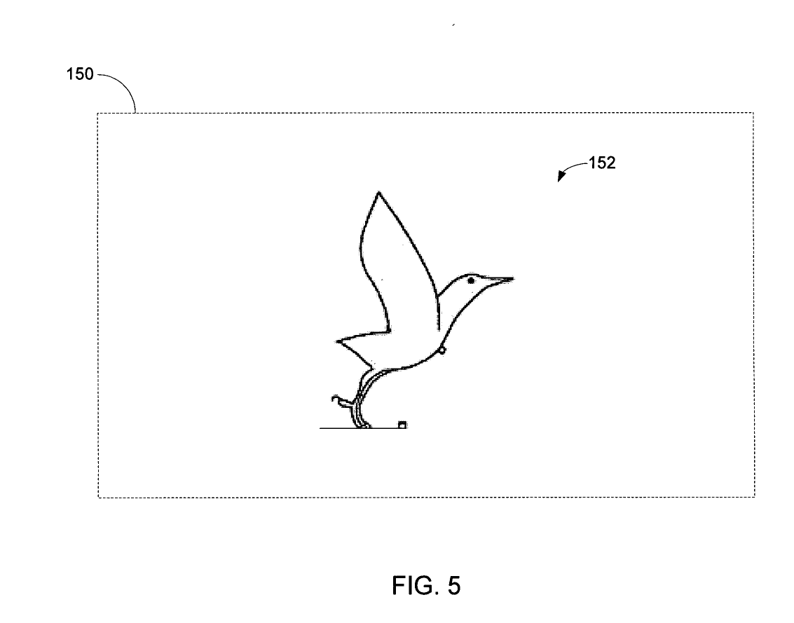

Motion triggering process 10 may take 104 at least a second picture after a predefined interval of time. Continuing with the above example, more than one picture of bird 152 taking flight may be desired. A time interval may be programmed into camera system 12 causing motion triggering process 10 to take 104 at least a second picture after the specified time interval, e.g., half a second. For example, and referring also to FIG. 5, after half of a second bird 152 may have moved further in the process of taking flight. Taking 104 the at least a second picture after the predefined interval of time may allow a sequence of pictures to be taken, capturing various views of bird 152, at the predefined time interval, during the process of taking flight. While a time interval of half a second has been described, this is not intended as a limitation of this disclosure, as various different time intervals may be defined depending upon design criteria and user need.

Continuing with the above-stated example, motion triggering process 10 may take a plurality of pictures at predefined time intervals. For example, a sequence of pictures may be taken of bird 152 taking flight. Motion triggering process 10 may take 106 a predetermined number of pictures over a predefined period of time. The number of pictures to be taken 106 and the time interval between each successive picture may be defined, e.g., by a user (not shown) via any variety of user interface controls (not shown) associated with camera system 12. A user may want to take a certain number of pictures of a certain amount of time.

Motion triggering process 10 may detect 108 a level of light. For example, camera system 12 may include a light meter (e.g., light meter 24). Light meter 24 may be configured to measure a light level available to imaging device 18, and to provide a light level signal based upon, at least in part, the measured light level. Motion triggering process 10 may detect 108 the level of light, for example, based upon the light level signal provided by light meter 24.

Motion triggering process 10 may determine 110 if the light level is above a predefined threshold light level. If the light level detected 108 by motion triggering process 10 (e.g., via light meter 24) is above the predefined threshold light level, motion triggering process 10 may take 102 at least one picture of the object framed in viewing field 150. If the light level detected 108 by motion triggering process 10 (e.g., via light meter 24) is below the predefined threshold light level, motion triggering process 10 may provide 112 flash illumination, e.g., to achieve a light level above the predefined threshold light level.

Continuing with the above-stated example, camera system 12 may include flash device 26. Upon determining 110 that the detected 108 light level is below the predefined threshold light level, motion triggering process 10 may provide 112 flash illumination by triggering flash device 26. When triggered by motion triggering process 10, flash device 26 may provide the necessary illumination to achieve a light level equal to, or above, the predefined threshold light level. Motion triggering process 10 may take 102 at least one picture of the object (e.g., bird 152) illuminated by flash device 26.

A number of implementations have been described. Nevertheless, it will be understood that various modifications may be made. Accordingly, other implementations are within the scope of the following claims.

What is claimed is:

1. A method comprising:
detecting a change in motion of at least a portion of an object framed in a viewing field of a camera; and
taking at least one picture of the object upon the detection of the change in motion of at least a portion of the object if a level of light is at least a predefined threshold level of light.

2. The method of claim 1, wherein the camera includes one of a chemical film based camera, a digital camera, a video camera, a web camera and a camera phone.

3. The method of claim 1, wherein the change in motion of at least a portion of the object includes one or more of a start of motion of at least a portion of the object and a stop of motion of at least a portion of the object.

4. The method of claim 1, further including taking at least a second picture after a predefined interval of time.

5. The method of claim 4, wherein taking at least a second picture after a predefined interval of time includes taking a plurality of pictures at predefined time intervals.

6. The method of claim 1, further including taking a predetermined number of pictures over a predefined period of time.

7. The method claim 1, further including;
detecting the level of light.

8. A computer program product residing on a computer readable medium having a plurality of instructions stored thereon which, when executed by a processor, cause the processor to perform operations comprising:
detecting a change in motion of at least a portion of an object framed in a viewing field of a camera; and
taking at least one picture of the object upon the detection of the change in motion of at least a portion of the object if a level of light is at least a predefined threshold level of light.

9. The computer program product of claim 8, wherein the camera includes one of a chemical film based camera, a digital camera, a video camera, a web camera and a camera phone.

10. The computer program product of claim 8, wherein the change in motion of at least a portion of the object includes one or more of a start of motion of at least a portion of the object and a stop of motion of at least a portion of the object.

11. The computer program product of claim 8, further including taking at least a second picture after a predefined interval of time.

12. The computer program product of claim 11, wherein taking at least a second picture after a predefined interval of time includes taking a plurality of pictures at predefined time intervals.

13. The computer program product of claim 8, further including taking a predetermined number of pictures over a predefined period of time.

14. The computer program product of claim 8, further including;
detecting the level of light.

15. A camera system comprising:
an imaging device configured to take one or more pictures of one or more objects within a viewing field;
a motion detection device configured to detect a change in motion of at least a portion of the one or more objects within the viewing field and to provide a motion detection signal based upon, at least in part, the detected change in motion; and
a processor configured to receive the motion detection signal from the motion detection device and to trigger the imaging device to take the one or more pictures based upon, at least in part, the motion detection signal if a level of light is at least a predefined threshold level of light.

16. The camera system of claim 15, further including a light meter configured to measure a light level available to the imaging device, and to provide a light level signal, based upon at least in part the measured light level, to the processing logic, the processing logic being configured to trigger the imaging device to take one or more pictures if the light level signal indicates a measured light level greater than a predefined threshold light level.

17. The camera system of claim 15, further including a flash device configured to achieve the at least a predefined threshold level of light available to the imaging device.

18. The camera system of claim 15, wherein the change in motion of at least a portion of the object includes one or more of a start of motion of at least a portion of the object and a stop of motion of at least a portion of the object.

19. The camera system of claim 15, wherein the imaging device includes one of a chemical film based imaging device, a digital imaging device, and a video imaging device.
